(19) United States
(12) Patent Application Publication
(10) Pub. No.: US 2009/0149590 A1
(43) Pub. Date: Jun. 11, 2009

(54) Modified Polyamides, Uses Thereof and Process for Their Preparation

(75) Inventors: Michael Eroshov, Nahariya (IL); Ariel Yedvab, Ginegar (IL); Luca Ciceri, Rho (mi) (IT); Naman Asere, Kfar Salam (IL)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Nilit Ltd., Migdal Haemek (IL)

(21) Appl. No.: 12/088,425

(22) PCT Filed: Sep. 14, 2006
(86) PCT No.: PCT/IL2006/001084

§ 371 Date: Jul. 10, 2008

(30) Foreign Application Priority Data
Sep. 29, 2005 (IL) 171189

(51) Int. Cl. C08K 3/40; C08L 77/06; C08K 3/34; C08K 3/08; C08K 3/32

(52) U.S. Cl. 524/417; 525/418; 525/420; 524/606; 524/447; 524/451; 524/439; 524/456

(57) ABSTRACT

A polymeric matrix having improved flowability and wettability is provided, as well as a process for making it. The matrix contains a polyamide and a polyhydric alcohol which is chemically bonded at least to a part of the polyamide, and it is suitable particularly for manufacturing fiber-reinforced polyamide articles exhibiting a very good surface appearance and excellent mechanical properties.

### FIELD OF THE INVENTION

The present invention relates to polyamides. More particularly, the present invention relates to polyamides modified by a polyhydric alcohol, with decreased melt viscosity, improved lubrication, and improved wettability of various fillers.

### BACKGROUND

In the field of technical plastics, it is often sought to modify polymer compositions in order to impart advantageous properties to articles shaped therefrom or from compositions comprising them, the properties including mechanical strength, surface aspect, etc. Polymer compositions often comprise fillers intended to modify the mechanical properties or to reduce the costs of the material. If the fillers are present in large amounts, the surface aspect of the articles obtained may become unsatisfactory. In many fields it is sought to obtain articles whose surface aspect is shiny or which shows good reflectivity of light. There is a growing need for a resin composition with a high flowability for molding small items with thin walls or precision parts. The term “flowability” refers to the melt viscosity of a resin, and its ability to flow through narrow or complicated shapes. To provide a polyamide resin composition with higher flowability and decreased melt viscosity, a metal salt of a higher fatty acid such as aluminum stearate or an amide lubricant such as ethylene bis-(stearylamide) is admixed. However, large amounts of said materials are required to achieve a significant viscosity-reducing effect by this method. Furthermore, incorporation of such organic additive materials entail disadvantages; e.g., sublimated substances adhere to the vent portions during compounding, gases are generated during molding, mold deposits adhere on the molds, etc.

Significant efforts in the field of polyamides have been invested in developing polymer compositions of improved flowability. Resin suppliers like DSM, Rhodia, DuPont, Bayer, and BASF have come up with a cost-effective solution in novel high-flow nylon 6 grades that enhance surface quality and productivity, such as Technyl Star (Rhodia), Akulon Ultraflow (DSM), EasyFlow (Bayer) etc. These products are based on a polyamide of AB type, i.e. a polyamide prepared from a bifunctional monomer which contains an acid and an amine end groups, as for example polyamide 6, and which are manufactured by polycondensation with the addition of multifunctional compounds serving as branching agents. The polyamides of branched star-like structure provide such advantages in comparison to the conventional products as faster cycle times, easier processing and cost saving, aesthetic molded surface finish, reinforcement up to 65%, creating materials with very high stiffness and dimensional stability at elevated temperatures, competing with higher cost aromatic polyamides, and easily accommodating large, complex and thin part configurations. However, though the new polyamides have advantages such as decreased melt viscosity in the manufacturing of mineral-filled composites, including short glass fibers reinforced composites and long glass fibers reinforced composites, the polymers are not chemically modified to improve wettability of filling material with the polymers. The wettability is a decisive factor influencing mechanical properties and nice outer appearance of molded articles, which are features requested by automotive, electronics and other markets.

Moreover, the above mentioned advantages of AB type polyamide products are not achievable with polyamides of AABB type, i.e., polyamides obtained by a condensation reaction of bifunctional acids with bifunctional amines, as for example polyamide 66; therefore commercially available highly flowable polyamide 66 would be highly desirable.

There is still a growing demand for polyamides which could provide better mechanical properties, reduced equipment wear, excellent surface with the possibility of more complex designs, and enable improvements in productivity, cost saving and open up design. In particular, polyamide 66 of improved flowability and wettability with glass fibers and mineral fillers is badly needed due to its thermal and mechanical properties which are superior to polyamide 6.

Most of the recent developments of polyamides with improved properties in injection molding of large, complex and thin configuration parts, and compounding with glass fibers and mineral fillers are based on polyamides having improved rheological properties, i.e. decreased melt viscosity, in most cases due to a branched structure. These polyamides can be used for the manufacture of various articles, such as films, yarns, fibers or molded articles, which may or may not comprise fillers. The synthesis of macromolecules with star architecture is performed with almost all polymerization methods by two general approaches: a) by terminating reaction of linear polymer with a multifunctional agent, or b) by initiating polymerization with a multifunctional agent. However, incorporating multifunctional monomers with AA and BB monomers results in crosslinking between polymer chains and eventual gelation. The point at which gelation occurs depends on the average functionality of the monomer mixture and the conversion of functional groups. Therefore, introducing a multifunctional agent prior to the polymerization process is acceptable mainly to AB polyamides.

The below mentioned JP 6009777, FR 2743077, WO 99/64496, EP 345 648 and US 2002/0022712 deal with AB polyamides only. Polyamides of AABB type are not considered in these patents, which are aimed at improving flowability of a polyamide, and achieving improved performance in the polymer applications through decreased melt viscosity which the polymers of branched structure have. In industrial practice it is very difficult to exert precise control over the composition of such polymers in a reliable way, since their composition is in a direct relationship to their rheological and mechanical properties. Moreover, no modification is made in the abovementioned patents to improve compatibility of the polymer matrix with fillers by providing a polymer with better wettability toward the filler material.

JP 6009777 (U.S. Pat. No. 5,346,984) describes a star-shaped nylon 6 with low melt viscosity which is prepared by making use of a star-shaped tetrasubstituted carboxylic acid as a polymerization core of a rigid structure to prevent formation of intermolecular network among the polymer chains to further decrease melt viscosity. The star-shaped nylon is produced by homogeneously mixing the aromatic compound with molten nylon monomer and polymerizing the nylon monomer with the respective polymerization initiation groups as the starting points.

FR 2743077 (U.S. Pat. No. 6,160,080) describes compositions comprising fillers and a polyamide modified with a multifunctional compound, which polyamide exhibits a star-like structure obtained via polycondensation of caprolactam in the presence of a multifunctional compound capable of forming an amide functional group. The polyamide has, at least partially, a macromolecular structure in starburst form with repeating units of polyamide-6 type. Such compounds are known as starburst polyamides. These polyamides have a high melt-flow index, which makes it possible to increase the filler content in the composition without deteriorating the surface aspect, i.e. without observing the fillers at the surface of the articles. The polyamide is obtained by copolymerization of a multifunctional compound with monomers of amino acid or lactam type.

WO 99/64496 (U.S. Pat. No. 6,525,166) concerns a polyamide comprising macromolecular chains having a star-shaped configuration, a method for making said polyamide and compositions comprising same. More particularly, the invention concerns a method for making a polyamide comprising linear macromolecular chains and star-shaped macromolecular chains with control of the star-shaped chain concentration in the polymer. Said control is obtained by using besides the polyfunctional polymers and amino acids or lactams, a polyfunctional comonomer comprising either acid functions or amine functions. The resulting polyamide has optimal mechanical and rheological properties for improving the speed and quality of mould filling and for producing moldable compositions comprising high filler factors. EP 345 648 and US 2002/0022712 propose randomly branched polyamide based on AB monomers, while US 2002/0022712 offers intrinsically gel-free, randomly branched polyamide that cannot form a crosslinked polyamide (and thus no gels either) due to use of proprietary combinations of carboxylic acids or amines with different functionalities.

A method for improving flowability of AABB polyamide by modification in the course of polycondensation is presented in WO 97/08222 A1 (U.S. Pat. No. 5,824,763), which teaches that nylon compositions with improved flow can be prepared by polymerizing a diacid and a diamine, aminocarboxylic acid or lactam in the presence of excess of either acid or amine such that the ratio of acid to amine end groups or the ratio of amine end groups to acid end groups in the polymer is at least 2.0:1.0. However, only insignificant decrease in melt viscosity was achieved, while in order to attain the required relative viscosity the polymer was subjected to more prolonged heat treatment below atmospheric pressure and even at higher temperatures, which conditions cause discoloration of the polymer and deterioration of its mechanical properties due to thermal degradation.

A method for improving flowability of polyamide of AABB type is via terminating reaction of linear polymer with multifunctional agent at the time of an extrusion process (EP 0 672 703, WO 01/96441, NL 1017503C, WO 01/96474) or compounding of AABB type polyamide with flow-modified polyamide of AB type. EP 0 672 703 (U.S. Pat. No. 5,859,148) describes a process for producing different starburst polyamides, by introducing a multifunctional compound into a polyamide during an extrusion operation; a decrease in pressure in the extrusion device is observed for various polymers. It is mentioned that the process enables star-branched polymers to be prepared, also from AABB polycondensates, but mechanical properties of nylon 66 are shown to decline.

WO 01/96441 (U.S. Pat. No. 6,864,354 B2, US 2004/0030057 A1) concerns modified polyamides comprising units of the type obtained by reacting a diacid with a diamine, modified by a multifunctional compound. The polyamide is obtained by mixing in melted state polyamides of different types, in the presence of a multifunctional compound comprising at least three reactive functions, chosen from amines, carboxylic acids and derivatives thereof, the reactive functions being identical. The invention proposes a modified polyamide obtained by melt-reacting polyamide of AABB type like nylon 66, polyamide of AB type like nylon 6 and a multifunctional modifier like 2,2,6,6-tetra(beta-carboxyethyl)-cyclohexanone. The compositions according to the invention have good thermomechanical properties, which are attributed to the presence of the AABB polyamide.

NL 1017503C (US2005/004312) offers a process for preparing a polyamide composition with a non-newtonian melt-flow behavior, which comprises melt mixing a polyamide having a lower viscosity and substantially newtonian melt-flow behavior with a chain branching agent containing anhydride groups, wherein the branching agent consists of (a) 5-75 mass % (wt %) of a copolymer of at least an unsaturated dicarboxylic acid or a derivative thereof and a vinyl aromatic monomer; (c) 5-75 wt % of a copolymer of acrylonitrile and a vinyl aromatic monomer; (c) 10-80 wt % of a homo- or copolymer of ethylene or propylene; and (d) 0-10 wt % customary additives.

WO 01/96474 (US 2004/0024115) offers a polyamide which is obtained by mixing in melted form a polyamide and a polyamide macromolecular compound comprising star-shaped or H-shaped macromolecular chains, in particular polyamide 66 and a starburst polyamide 6.

JP 2000345031 offers a polyamide composition suppressed in scattering of a flow modifier, and having good fluidity and good mechanical strengths, by adding to a polyamide resin a specified amount (0.005-5%) of a polyhydric alcohol having a melting point of 150-280° C. The polyamides used are those having a melting point of 160-320° C. such as polyamide 6, polyamide 66, polyamide 6/66, polyamide 6/6T, polyamide 66/6T, polyamide 6616T/61, or the like. The polyhydric alcohols used are pentaerythritol, dipentaerythritol, trimethylolethane, or a mixture thereof. Despite the fact that polyhydric alcohols have a good affinity to inorganic fillers, they are not bound to the polymer, and the polyamides containing them are subjected to degradation and discoloration under the conditions of compounding. Obviously, for these reasons the compositions exemplified in the patent are black-colored in order to hide the discoloration. This method does not provide a sufficient dispersion effect, the polyhydric alcohol is liable to bleed out from a resin molded article, and, in addition, is easily extracted from the polymer by water, or alcohol such as ethanol. On the other hand, only a moderate increase in flowability is achieved in the method.

In conclusion, it should be emphasized that a) although having a decreased melt viscosity, the above mentioned polymers do not have a lubricating property and use of lubricant is still required when using them for molding, b) all the above mentioned methods (both polymerization based and compounding-based, apart from JP 2000345031, do not employ chemicals which may improve wettability of fillers with the polymer, c) compounding process does not allow the same degree of mixing homogeneity as mixing at the time of polymerization, and d) by now there is no process for manufacturing highly flowable polyamides of AABB type which would permit using the advantageous thermomechanical properties of AABB type polyamides like polyamide 66 in glass- and mineral-filled compositions.

Short fiber thermoplastic composites are attracting more and more attention because of their widespread applications. Compared to their matrices, short fiber thermoplastic composites exhibit improved mechanical, electrical and thermal properties. It is well recognized that dispersion, wetting and interaction between fiber and polymeric matrix are critical factors in designing fiber reinforced polymer composites. In recent years, considerable efforts have been made to modify the fiber-matrix interface. The most common method used is to treat the glass fibers with low-molecular weight coupling agents, dispersants, or surfactants. A growing number of grafting techniques have also been proposed for glass fibers for improving interface interaction, which results in enhanced mechanical properties. However, no satisfactory results have yet been obtained.

Again, difficulties in the pultrusion of polyamides (Gong glass fibers) also result from the poor wet-out of the fibers. Adequate wetting of the fibers in a pultrusion process with a melt is not easily achieved. Among the problems occurring are fiber roving breakage, lowering of line speeds to promote wet-out, and polymer degradation. Any attempt to improve production by reducing the pultrusion matrix polymer melt viscosity, such as by increasing the melt temperature, runs a greater risk of operating in an unstable thermal window. Other methods to reduce melt viscosity of the pultrusion matrix polymer by blending the matrix polymer with higher melt-flow materials is accompanied by undesired loss in physical properties, greater complexity and/or cost. For a variety of reasons, such as the need to reduce costs and to fabricate lighter structures, improved flexural and tensile modulus are desired from less costly polymer composites. Desirable thermoplastic materials, such as polyamides, in particular polyphthalimides which otherwise provide inherently high modulus, and physical properties at high in-service temperatures have limits on moldability. The high volume content of fibers results in relatively little polymer being available at the surfaces of the work pieces to be joined. Differences in the dispersion patterns of the long fibers result in variations in the physical properties of the molded composite.

Thus, there is still a growing demand for polyamides and compositions thereof which could provide better mechanical properties, reduced equipment wear, excellent surface with the possibility of more complex designs, and enable improvements in productivity, cost saving and open up design. In particular, polyamide 66 of improved flowability and wettability of glass fibers and mineral fillers is highly needed due to its good thermal and mechanical properties which are superior to polyamide 6.

It is therefore an object of the present invention to provide polyamides which have improved flowability and wettability.

Still another object of the present invention is to provide polyamides having varying flowability and wettability in wide ranges.

Still another object of the present invention is to provide polyamides with improved flowability and wettability adapted to different applications.

Still another object of the present invention is to provide polyamides having improved wettability and flowability, good mechanical, and rheological properties, and excellent surface aspect.

It is also an object of the present invention to provide a polymeric matrix suitable for manufacturing fiber-reinforced polyamide articles.

It is yet another object of the present invention is to provide a process for the manufacture of polyamides having improved flowability and wettability.

Yet another object of the present invention is to provide a high throughput and cost-effective process for the manufacture of such polyamides.

Yet another object of the present invention to provide articles comprising such improved polyamides.

It is yet another object of the present invention to provide composite articles comprising improved polyamides and having good mechanical qualities and a good surface aspect.

It is yet another object of the present invention to provide composite materials comprising polyamide matrices having improved flowability, and wettability of the reinforcing component. In one particular aspect of the present invention short and long glass reinforcing fibers are used in composites comprising matrices of the improved polyamides of the present invention.

It is yet another object of the present invention to provide long glass fibers-reinforced composite articles comprising improved polyamides, wherein said long glass fibers-reinforced composites are prepared by pultrusion method.

This and other objects of the present invention shall become clear as the description proceeds.

### SUMMARY OF THE INVENTION

The present invention relates to high-flowability polyamides which have decreased melt viscosity, improved lubrication and improved wettability of various potential fillers. More particularly, the present invention relates to polyamides, modified by multifunctional polyhydric alcohols. Finished articles formed from said polyamides or from compositions based on said polyamides exhibit excellent mechanical properties, as well as a very good surface appearance, and can be manufactured with a high throughput as compared to conventional products. In another aspect, the invention also proposes a process for obtaining such polyamides and compositions comprising them. In one particular aspect the present invention relates to a polyamide resin composition used in molded products. Finished articles formed from modified polyamides of the present invention or from compositions based on said polyamides exhibit excellent mechanical properties, as well as a very good surface appearance. The inventive modified polyamide is obtained by adding a polyhydric alcohol to a polymerization mixture prior to or in the course of polymerization. One object of the present invention is to propose a novel modified polyamide of high flowability and improved lubrication property, the thermomechanical properties of which are satisfactory, and which has improved wettability of various fillers. The modified polyamide can be used for both filled and unfilled applications. When used as a matrix with fillers, the modified polyamide makes it possible to obtain articles whose surfaces show good reflectivity and excellent mechanical properties, while allowing energy-consuming compounding and injection molding with an increased throughput as compared to the conventional polyamide. An object of the invention is thus also to propose filled compositions that have an excellent surface aspect and mechanical properties. Another object of the invention is the provision of a method for obtaining such polyamides and their compositions. To this end, the invention proposes a modified polyamide capable of being obtained by addition of a polyhydric alcohol having at least three hydroxyl functional groups to a polymerization medium, prior to or at any stage of the polymerization process. Desired mechanical and rheological properties of the polyamide can be further adjusted, for example, by varying amount of polyhydric alcohol, duration of keeping the polymer under a low pressure at a final stage of the polymerization process, and by addition of an appropriate amount of mono- or di-functional acid or mono- or di-functional amine.

The polyamide, which comprises the polyhydric alcohol, can be inherently stabilized against degradation caused by heat, light and oxidation by incorporating stabilizing materials directly into the polymer chain using such reagents as 4-amino-2,2,6,6-tetramethylpiperidine and 3,5-di-t-butyl-4-hydroxyphenyl-propionic acid, and also adding phosphorus-containing antioxidants like sodium hypophosphite etc. This method can be used in conjunction with other well known techniques for flow enhancement or melt viscosity reduction.

The invention essentially provides an improved polymeric matrix suitable for manufacturing fiber-reinforced polyamide articles, having excellent flowability and wettability, comprising i) a polyamide; and ii) at least one polyhydric alcohol containing three or more hydroxyl groups in the molecule; wherein said polymeric matrix is obtained essentially by incorporating said polyhydric alcohol to the monomers or to a polymerization medium of said polyamide prior to or in the course of the polymerization process of said polyamide, and wherein said polyhydric alcohol is chemically bonded at least to a part of the polymer. Bonding to a part of the polymer means that some polyamide molecules will comprise said polyhydric alcohol, for example coupled by esteric bonds. It is understood that one or more hydroxyl groups in the molecule of said polyhydric alcohol may participate in the bonding reaction. When two or three, or more, hydroxyl groups in the molecule of said polyhydric alcohol participate in the bonding reaction, branched structures are formed. The polymer in said polymeric matrix is obtained by condensation reaction in a mixture selected from mixtures comprising diacids with diamines or salts thereof, mixtures comprising a lactam, and mixtures comprising an aminocarboxylic acid, in the presence of at least one polyhydric alcohol. Said polymer may be a copolyamide obtained by condensation reaction in a mixture comprising aminocarboxylic acids or lactams with diamines and diacids. The precursors of the polymer may be selected from the group consisting of lactams; monomers and oligomers of a C₂ to C₁₈ amino acid; monomers and oligomers of a C₂ to C₁₈ alkyl diamine with a C₂ to C₁₈ aliphatic diacid; monomers and oligomers of a C₂ to C₁₈ alkyl diamine with a C₈ to C₂₄ aryl diacid or aryl diacid derivative; monomers and oligomers of a C₆ to C₂₄ aryl diamine with a C₈ to C₂₄ aryl diacid or aryl diacid derivative; monomers and oligomers of a C₆ to C₂₄ aryl diamine with a C₂ to C₁₈ alkyl diacid or alkyl diacid derivative; monomers and oligomers of a C₈ to C₁₄ aralkyl diamine with a C₁₀ to C₁₄ aralkyl diacid or diacid derivative; and any combinations thereof. Said diacids may be selected from the group consisting of adipic acid, sebacic acid, suberic acid, dodecanedioic acid, azelaic acid, terephthalic acid, isophthalic acid, 5-sulfoisophthalic acid, succinic acid, glutaric acid, dodecandioic acid, dimer acid, terephthalic acid, cyclohexane dicarboxylic acid, 2,6-naphthalene dicarboxylic acid, tert-butyl isophthalic acid, and phenylindanedicarboxylic acid. Said diamines may be selected from the group consisting of hexamethylene diamine, tetramethylene diamine, pentamethylene diamine, 2-methyl pentamethylene diamine, 3,3-dimethyl-4,4′-diaminocyclohexylmethane, 1,6-diamino-2,2,4-trimethylhexane, 1,6-diamino-2,4,4-dimethylhexane, m-xylylenediamine, p-xylylenediamine, diaminononane, diaminodecane, diaminododecane, 2,2-bis(p-aminocyclohexyl)propane, bis(p-aminocyclohexyl)methane, isophorondiamine, polypropyleneglycoldiamine, norbornanediamine, and 1,3-bis(aminomethyl)cyclopentane. Said lactams may be selected from caprolactam, laurolactam, and enantholactam whose aminocarboxylic acid is either omega-aminoundecanoic acid or omega-aminododecanoic acid. The polymeric matrix of the invention preferably comprises nylon 66 or nylon 6. Said polyhydric alcohol may be selected, for example, from the group consisting of trimethylolethane, trimethylolpropane, trimethylolbutane, pentaerythritol, dipentaerythritol, ditrimethylolpropane, erythritol, mesoerythritol, inositol, sorbitol, D-mannitol, xylitol, galactitol, altritol, iditol, ribitol, D-arabitol, glucose, lactose, fructose, sucrose, mixtures thereof, and derivatives thereof capable of supplying polyhydric alcohol to a polymerization medium of said polyamide as a result of a chemical change. The polymer in the polymeric matrix of the invention is preferably partially branched as a result of said bonding. Partial branching means that some polyamide molecules of the polymeric matrix will be branched, which may be achieved, for example, by coupling of three or more polyamide chains to the same molecule of polyhydric alcohol. Said polyhydric alcohol in the polymeric matrix of the invention contains preferably three or more hydroxyl groups in the molecule, an example being trimethylolethane, trimethylolpropane, pentaerythritol, dipentaerythritol, mannitol, and sorbitol. A polymeric matrix according to the invention preferably contains at least 40 meq/kg of free carboxyl groups, and more preferably at least 60 meq/kg of free carboxyl groups. The polymeric matrix of the invention exhibits improved flowability, wettability, and lubrication, and also exhibits decreased melt viscosity. Relative viscosity of the polymeric matrix may be as low as 34 or less, which is especially suitable for filled composites of the invention.

The invention further provides a composition comprising i) the polymeric matrix comprising polyamide and a polyhydric alcohol, triol or higher, chemically bonded at least to a part of the polyamide, and ii) at least one filler selected from reinforcing or bulking fillers. Said filler may be selected from the group consisting of glass fibers, carbon or inorganic fibers, kaolin, wollastonite, talc, metal powders, and nanoclays, and may be present in the composition in an amount of from about 5 wt % to about 80 wt %. Said glass fibers may be long length fibers present in the composition preferably in an amount in the range of about 5 wt % to about 80 wt %, more preferably of about 20 wt % to about 65 wt %. The composition comprising said long fibers may be obtained by pultrusion process. Said glass fibers may be short length fibers present in the composition preferably in an amount in the range of about 5 wt % to about 80 wt %, more preferably in an amount of from about 20 wt % to about 65 wt %. Said filler may comprise a flame-retardant. Said filler may comprise carbon black, preferably in an amount less than or equal to about 6 wt %. The composition of the invention may further comprise at least one other filler selected from the group consisting of mineral fillers, metal powders, UV stabilizers, antioxidants, pigments, dyes, nucleating agents, crystallization accelerators, flame retardants, impact modifiers, conducting additives, anti-fogging agents, optical brighteners, fragrances, fungistatics, oxidation retardants, light and heat stabilizers, flow promoters, lubricants, and mold release agents. A preferred composition of the invention comprises i) a polymeric matrix having improved flowability and wettability comprising polyamide and at least one alcohol containing three or more hydroxyl groups in the molecule, wherein said alcohol is chemically bonded at least to a part of said polyamide; ii) glass fibers in an amount of from 20 to 80 wt %; and optionally iii) a second filler. The composition of the invention enables a high degree of glass fiber loading, which may be 50 wt % or more.

The invention also provides a process for the manufacture of a polymeric matrix as defined above, said process comprising polymerizing a polyamide in the presence of at least one polyhydric alcohol containing three or more hydroxyl groups in the molecule, and optionally introducing a filler to a melt of said polyamide. Said polyhydric alcohol may be present in an amount in the range of about 0.05 wt % to about 10 wt %, preferably of about 0.1 wt % to about 5 wt %. Said process may further comprise adding phosphorus-containing antioxidant, preferably said antioxidant being sodium hypophosphite. Said phosphorus-containing antioxidant may be present in the polyamide in an amount in the range of about 5 to about 10000 ppm as elemental phosphorus. In the process of the invention, the polyamide may be stabilized with a hindered amine and/or hindered phenol-containing compound bonded to the polyamide amine or carboxyl end groups. Said hindered phenol-containing compound may be 3,5-di-t-butyl-4-hydroxyphenyl-propionic acid, preferably added in an amount in the range of about 0.05 wt % to about 1.0 wt %, more preferably of about 0.1 wt % to about 0.8 wt %, and most preferably of about 0.15 wt % to about 0.5 wt %, optionally added as an aqueous salt solution with the equimolar amount of 4-amino-2,2,6,6-tetramethylpiperidine or hexamethylenediamine. Said hindered amine compound is preferably 4-amino-2,2,6,6-tetramethylpiperidine, preferably added in an amount in the range of about 0.05 wt % to about 1.0 wt %, more preferably of about 0.2 wt % to about 0.8 wt %, most preferably of about 0.25 to about 0.5 wt %. The process of the invention may comprise adding capping agents, preferably said capping agents being selected from the group consisting of mono- or di-functional acids such as acetic acid, propionic acid, benzoic acid, isophthalic azelaic acid, sebacic acid, acid, terephthalic acid, mono- or di-functional amines such as benzyl amine, tetramethylene diamine, 2-methyl pentamethylene diamine, 3,3′-dimethyl-4,4′-diaminocyclohexylmethane, m-xylylenediamine, p-xylylenediamine, diaminononane, diaminodecane, bis(p-aminocyclohexyl)methane, 1,3-bis(aminomethyl)cyclohexane, and mixtures thereof, most preferably, said capping agents are selected from the group consisting of adipic acid, 3,5-di-t-butyl-4-hydroxyphenyl-propionic acid, hexamethylenediamine, 4-amino-2,2,6,6-tetramethylpiperidine, and mixtures thereof.

The invention further provides a polyamide article comprising a polymeric matrix as described above, said article exhibiting excellent mechanical properties and improved surface aspect, and further exhibiting improved rheological properties when molten. Finally, the invention provides a polyamide article comprising a composition as described above, said article exhibiting improved mechanical properties and surface aspect, and further exhibiting improved rheological properties when molten. The polymeric matrix comprising a polyamide and a polyhydric alcohol according to the invention exhibits low bleeding of the polyhydric alcohol during compounding, extrusion or application, and further said matrix exhibits at least a partial retention of the polyhydric alcohol when extracted by water or by an alcohol.

### DETAILED DESCRIPTION OF THE INVENTION

The invention makes use of polyhydric alcohols for modification of polyamides obtained by a polycondensation process. The polyhydric alcohol is added to the starting monomers or to the polymerizing reaction mixture. The polymerization is preferably carried out according to conventional conditions for polymerizing the polyamide-forming monomers.

Polyamides useful in the present invention are well known in the art and include polyamides obtained by condensation of diacids and diamines or salts thereof (AABB type), and polyamides which are the condensation product of lactams or aminoacids (AB type). A polyamide precursor may be selected from the group consisting of lactams; monomers and oligomers of a C₂ to C₁₈ amino acid; monomers and oligomers of a C₂ to C₁₈ alkyl diamine with a C₂ to C₁₈ aliphatic diacid; monomers and oligomers of a C₂ to C₁₈ alkyl diamine with a C₈ to C₂₄ aryl diacid or aryl diacid derivative; monomers and oligomers of a C₆ to C₂₄ aryl diamine with a C₈ to C₂₄ aryl diacid or aryl diacid derivative; monomers and oligomers of a C₆ to C₂₄ aryl diamine with a C₂ to C₁₈ alkyl diacid or alkyl diacid derivative; monomers and oligomers of a C₈ to C₁₄ aralkyl diamine with a C₁₀ to C₁₄ aralkyl diacid or diacid derivative; and any combinations thereof.

Preferred diacids include adipic acid, sebacic acid, suberic acid, dodecanedioic acid, azelaic acid, terephthalic acid, isophthalic acid, 5-sulfoisophthalic acid, succinic acid, glutaric acid, dodecandioic acid, dimer acid, terephthalic acid, cyclohexane dicarboxylic acid, 2,6-naphthalene dicarboxylic acid, tert-butyl isophthalic acid, phenylindanedicarboxylic acid. Preferred diamines include hexamethylene diamine, tetramethylene diamine, pentamethylene diamine, and 2-methyl pentamethylene diamine, 3,3′-dimethyl-4,4′-diaminocyclohexylmethane, 1,6-diamino-2,2,4-trimethylhexane, 1,6-diamino-2,4,4-trimethylhexane, m-xylylenediamine, p-xylylenediamine, diaminononane, diaminodecane, diaminododecane, 2,2-bis(p-aminocyclohexyl)propane, bis(p-aminocyclohexyl)methane, isophorondiamine, polypropyleneglycoldiamine, norbornanediamine, 1,3-bis(aminomethyl)cyclopean. Preferred aminocarboxylic acids and the corresponding lactams include caprolactam, laurolactam, enantholactam, omega-aminoundecanoic acid, and aminododecanoic acid. Copolyamides formed by reaction of aminocarboxylic acids or the corresponding lactams with diamines and diacids can also be used. Though basically all ordinary lactams, aminocarboxylic acids, dicarboxylic acids and diamines can be used as the polyamide-forming monomers in the invention, the most preferred polyamide is polyamide 66 obtained from hexamethylenediamine and adipic acid and polyamide 6 obtained from caprolactam or aminocaproic acid.

Polyhydric alcohols employed in the present invention are widely used in the manufacture of alkyd resin paints, fatty acid resin and tall oil esters to make paint and coatings, printing ink, coating adhesives, explosives, sealants, varnish, lacquer, lubricants, surfactants, wetting agents, modifiers for metalworking, finishes in synthetic fiber processing, cosmetic emollient, thickeners, pigment dispersants, lubricants in both extrusion and molding processes, mold release agents, tackifiers in adhesives, non-polar plasticizers for synthetic resins with superior effect on the toughness of the composition, etc. Polyhydric alcohols also serve as carbonific material (charring source) in intumescent polymer compositions and intumescent coatings. In general, polyhydric alcohols and their derivatives are known for their good wetting various inorganic and organic materials and metals. As a result of extensive studies, the inventors of the present invention have found that the addition of polyhydric alcohol having at least three hydroxyl groups to monomers or to a polymerization medium prior to or in the course of polymerization process aimed at preparation of polyamide of AABB or AB type or copolyamide of AABB/AB type, results in a novel modified polyamide of high flowability. These novel modified polyamides have excellent thermomechanical properties, improved lubrication and improved wettability of various fillers, thus allowing, inter alia, preparation of filled compositions that have an excellent surface aspect and mechanical properties at a higher throughput and lower energy consumption. An improved lubrication means that less or no lubricant addition is needed, indicating in fact self-lubricating properties of the polymer.

While not wishing to be bound to a particular theory, it is believed that hydroxyl groups of the polyfunctional polyhydric alcohol react to form chemical bonds with carboxyl groups present in the polyamide (the fact of formation of ester bond is confirmed by D1 NMR and FTIR). Since hydroxyl groups of polyhydric alcohol are less reactive with carboxyl groups than amino groups, it is believed that the interaction occurs at the final stage of the polymerization, thus permitting introduction of polyhydric alcohol prior to or at any stage of a polycondensation process without causing gelation, irrespectively of the polyamide type (AABB or AB). It can also be supposed that the hydroxyl groups of the polyfunctional polyhydric interact with a network of hydrogen bonds present in polyamides. The bonding of a polyhydric alcohol to a polyamide in the method of the present invention is confirmed by extraction tests: the added polyhydric alcohol is only partially extracted by a solvent, while polyhydric alcohol is almost completely extracted from compositions having equal content of polyhydric alcohol, but prepared by compounding polyhydric alcohol with polyamide in an extruder. The incorporation of polyhydric alcohol of branched structure into polyamide makes the polymer highly flowable, while excellent wetting properties of polyhydric alcohol make the polymer highly compatible with various fillers. The obtained polyamide is substantially gel-free as opposed to the polyamide prepared by using conventional branching agents. This latter quality is important for the production of polyamides of AABB type, since the method enables manufacturing highly flowable polyamides of AABB type via a polymerization process. The polymer obtained by addition of polyhydric alcohol during polymerization process may have 3 times and larger flowability, based on MVR (melt volume-flow rate) measurement, than the polymer obtained by compounding polyhydric alcohol with polyamide with the same ratio. Moreover, the method allows eliminating such problems of the compounded product as discoloration due to thermal degradation of conventional flow enhancing agents at the time of compounding, and their bleeding-out from a molded article. The polyamides obtained according to the invented method are characterized in that their relative viscosity (measured in aqueous 90% solution of formic acid) is less than the relative viscosity of a conventional polyamide prepared without using polyhydric alcohol, depending on the amount of added polyhydric alcohol. However, the virgin polyamide of the present invention retains mechanical properties similar to those of the conventional polyamide. Moreover, compositions of the invented polyamide with various fillers have mechanical properties which are significantly superior to those of filled compositions of conventional polyamides. Molded articles made from the invented polyamide have excellent surface appearance, which advantage manifests itself in filled compositions with a high degree of filler loading, like short and long glass filled compositions having about 50% by weight and more loading of the fillers.

The polyhydric alcohols (or polyols) used in the present invention may be tri- or polyfunctional alcohols. Examples of compounds, having three or more hydroxyl groups in one molecule, are trimethylolethane, trimethylolpropane, trimethylolbutane, pentaerythritol, dipentaerythritol, ditrimethylolpropane, erythritol, mesoerythritol, inositol, sorbitol, D-mannitol, xylitol, galactitol, altritol, iditol, ribitol, D-arabitol, glucose, lactose, fructose, sucrose, mixtures thereof, and derivatives thereof capable of supplying polyhydric alcohol to a polymerization medium of said polyamide as a result of a chemical change.

The preferred polyhydric alcohols, which are suitable for the purpose of the present invention, are trimethylolethane, trimethylolpropane, pentaerythritol, dipentaerythritol, mannitol, and sorbitol.

The polymerization may be carried out batchwise or continuously, in a known manner, starting from polyamide precursor solutions using heat or heat and vacuum. A typical example of a batch process is a two stage process. In the first stage, one or more aqueous salt solutions are charged into an evaporator. The additives, including, inter alia, polyhydric alcohols, are conveniently added to the monomers, or with the salt solutions or sequentially during the advanced stages.

The polyhydric alcohol compound is added to the starting monomers or to the polymerization reaction mixture as an aqueous solution or slurry in water, depending on the solubility of a polyhydric alcohol, preferably in an amount in the range of about 0.05 to about 10 wt %, preferably of about 0.1 to about 5 wt. %. The amount of added polyhydric alcohol depends on desired fluidity, wettability and mechanical properties of the target polymer. Usually a higher amount of polyhydric alcohol is added if the polymer is intended for compounding with fillers. On the other hand, a lower amount of polyhydric alcohol is loaded if the polymer is intended for injection molding as is with no filling.

A polymer obtained by compounding with polyhydric alcohol in an extruder undergoes thermal degradation, causing deterioration of mechanical properties and discoloration. However, such phenomena occur in a far less extent in the polymer of the present invention. Nevertheless, it is also useful that the polyhydroxyl alcohol moiety in the polymer is further stabilized against degradation caused by light, heat and oxidation by bonding hindered amine and/or hindered phenol containing compound to the ends of the polymer chain through reaction of amino end groups or the carboxyl end groups of the polyamide being formed. The modified polyamide comprising polyhydric alcohol, can be inherently stabilized against degradation caused by heat, light and oxidation by incorporating stabilizing materials directly into the polymer chain. Non-limiting examples of such reagents are 4-amino-2,2,6,6-tetramethylpiperidine and 3,5-di-t-butyl-4-hydroxyphenyl-propionic acid. The reagents may be added to the starting monomers or the polymerizing reaction mixture and become bonded to the end of the polymer chain through reaction of its amino end group with the starting monomers or with the carboxyl groups of the polyamide being formed. 4-amino-2,2,6,6-tetramethylpiperidine can be added as is or as aqueous solution, while 3,5-di-t-butyl-4-hydroxyphenyl-propionic acid being a water-insoluble solid, may be added as an aqueous solution of its salt with an amine. 3,5-di-t-butyl-4-hydroxyphenyl-propionic acid for the purpose of the present invention can be used as an aqueous solution of a salt formed by 3,5-di-t-butyl-4-hydroxyphenyl-propionic acid with 4-amino-2,2,6,6-tetramethylpiperidine, ammonia or hexamethylenediamine, taken in equivalent amount.

The amount of added 4-amino-2,2,6,6-tetramethylpiperidine is in the range of about 0.05 to about 1.00 wt %, preferably of about 0.1 to about 0.8 wt %, most preferably of about 0.15 to about 0.5 wt %. The amount of added 3,5-di-t-butyl-4-hydroxyphenyl-propionic acid may be in the range of about 0.05 to about 1.0 wt %, preferably of about 0.2 to about 0.8 wt %, most preferably of about 0.25 to about 0.5 wt %.

The polymer of the present invention can further be improved in whiteness by adding into the polymerization medium phosphorus-containing antioxidants. Compounds suitable as antioxidant may be provided on the basis of hypophosphorous acid, phosphorous acid or phosphoric acid. Particular examples are phosphorous acid, sodium phenylphosphinate, sodium hypophosphite etc. Among these antioxidants, sodium hypophosphite is the preferred one.

It is well known to those skilled in the art that phosphorus-containing antioxidants when being added to the polymerization system act as catalysts. This is an effect that is undesirable in some cases, since it may lead to uncontrolled changes in relative viscosity and mechanical properties of the polymer. U.S. Pat. No. 6,191,251 teaches that the catalytic effect of certain phosphorus compounds can be reduced or inhibited completely with the addition of certain bases without significantly and adversely affecting the desired effect of phosphorus compounds of reducing the polymer color. The degree to which the phosphorus compound, acting as a catalyst, is deactivated depends on the amounts of phosphorus and base. The phosphorus compounds are phosphorous acids and their esters and salts, while the bases are carbonates, bicarbonates, hydroxides and alkoxides. However, this method requires addition of a relatively large amount of the basic inorganic material which chemically interacts with the polymer, and adversely affects mechanical properties of the resulting polyamide. For the above reason, the method has limitation on maximal amount of the phosphorus compound that can be introduced into the polymer, and therefore the positive effect of the invention manifests itself mainly in improvement of whiteness, while only a minor effect on stability of mechanical properties of the polymer at elevated temperatures is attained due to the relatively small amount of phosphorus-containing antioxidant which could be added to the polymer.

Surprisingly, it has been found that the catalytic activity of the phosphorus compounds like phosphorous acids, their esters, or salts in the polyamidation process, is effectively suppressed in the presence of polyhydric alcohols. The method of the present invention does not require addition of large amounts of basic inorganic material and have no limitation on the amount of the phosphorus-containing antioxidants within reasonable range of their use.

The amount of phosphorus-containing antioxidant according to the present invention is preferably in the range of about 5 to about 10000 ppm (as elemental P), more preferably of about 10 to about 300 ppm (as elemental P). The phosphorus-containing antioxidant can be conveniently added to the polyamide precursor salt solutions or during further stages of the polymerization process. Further, the phosphorus-containing antioxidant can be added as aqueous solution either independently or together with other additives.

Furthermore, the degree of bonding of incorporated polyhydric alcohol to the polyamide via esterification can be increased by changing the ratio between carboxyl and amino end groups in the polyamide in favor of the carboxyl end groups. On the other hand, in some cases it may be desirable that the polyamide have a prescribed content of amino end groups, which may be required, for example, for improved hydrolysis resistance, improved compatibility for compounding with maleic anhydride-grafted rubbers, etc. The amount of carboxyl and amino end groups in the polyamide can be adjusted by adding a proper capping agent, while keeping the same content of polyhydric alcohol in the polymer. Thus, better or further control over mechanical and rheological properties of the polymer composition is possible due to the use of capping agents.

The capping agents which are suitable for this purpose can be selected from mono- or di-functional acids or mono- or di-functional amines. Specific examples of acids are acetic acid, propionic acid, benzoic acid, 3,5-di-t-butyl-4-hydroxyphenyl-propionic acid, isophthalic adipic acid, azelaic acid, sebacic acid, terephthalic acid, and combinations thereof. Specific examples of amines are benzyl amine, 4-amino-2,2,6,6-tetramethylpiperidine, hexamethylene diamine, tetramethylene diamine, 2-methyl pentamethylene diamine, 3,3′-dimethyl-4,4′-diaminocyclohexylmethane, m-xylylenediamine, p-xylylenedi-amine, diaminononane, diaminodecane, bis(p-aminocyclohexyl)methane, 1,3-bis(aminomethyl)cyclohexane and combinations thereof. The capping agents can be used either independently or in any combination thereof. Preferred capping agents for this purpose are adipic acid, 3,5-di-t-butyl-4-hydroxyphenyl-propionic acid, hexamethylenediamine, 4-amino-2,2,6,6-tetramethylpiperidine, etc.

Whether acid or amine should be added, the choice depends upon a number of factors: original content of carboxyl end groups and amino end groups in the polymer (if prepared as is, without addition of a capping agent); effect of other additives used, on the content of carboxyl end groups and amino end groups in the polymer; object of the adjustment (compatibility with other fillers, hydrolysis resistance, mechanical properties, flowability, dyeability, etc.).

In order to provide a satisfactory bonding of polyhydric alcohol to polyamide for obtaining the polyamide matrix of the invention it is desirable that the content of carboxyl end groups in the polyamide modified with polyhydric alcohol is more than 40 meq/kg, preferably more than 60 meq/kg.

The polymer matrix suitable for manufacturing polyamide articles and fiber-reinforced polyamide articles can optionally include other additives such as antifoaming agents, catalysts, plasticizers, delusterants, pigments, dyes, antioxidants, antistatic agents, and the like as generally known in the art. If needed, the additives can be introduced during different steps of the process, for instance, before, during, or after the polymerization. In addition, additives may also be added to the polymerization medium as a solute or dispersion in an aqueous solution of a polyhydric alcohol. The catalysts that can be used in the process of the present invention may include polyamidation catalysts including L-lysine, phosphorous acid, etc, and polyesterification catalysts as titanium alkanoates, antimony trioxide, zinc acetate, tin octanoate, etc.

Further, mechanical properties of the polymer can also be adjusted as desired by changing process conditions at the final stage of the polymerization, for example by varying temperature, and duration of keeping the polymer under a low pressure at the end of the polymerization process.

The polyamide pellets thus produced can be used for molding at the relative viscosity at which the polyamide is produced, or can be further polymerized to a higher relative viscosity by conventional solid phase polymerization processes. Alternatively, the relative viscosity can be increased by other means such as by venting off water as the polymer is melted in the extruder.

The molded articles obtained from the virgin polyamide prepared according to the above-described process of the present invention exhibit excellent mechanical properties, decreased yellowness, and can be manufactured at a higher throughput as compared to the conventional products due to the improved mold release and lubrication, with no other processing aid and lubricants, thus solving such problems of the prior art as increased yellowness, adhering of the sublimated substances to the vent portions during injection molding, adhering of mold deposits on the molds, etc.

In one aspect, the present invention concerns filled molding compositions for the manufacture of moldings, sheets and fibers which are made of the polyamide prepared according to the present invention. The filled polyamide molding composition according to the present invention comprises, inter alia, conventional reinforcing materials or fillers for example mineral fillers, short or long glass fibers, carbon fibers, boron fibers, ceramic fibers, metal powders, and also UV stabilizers, antioxidants, pigments, dyes, nucleating agents, crystallization accelerators, flame retardants, impact modifiers, conducting additives, anti-fogging agents, optical brighteners, fragrances, fungistatics, oxidation retardants, light and heat stabilizers, and optionally flow promoters, lubricants, and mold release agents. Generally, every filler, particularly fiber fillers, commonly used in composite materials is suitable for the polyamide molding composition of the present invention either singly or in combination with other fillers. Most favorable fillers according to the present invention are short or long glass fibers.

Details in the method of producing the reinforced compositions of the present invention are not critical so long as an intimate mixture of the components is produced, i.e., a uniform mixture which will not delaminate on processing. As mentioned above, the reinforced compositions of the present invention may contain other materials such as antioxidants, stabilizers, impact modifiers, mold release agents, fire retardant chemicals, and other materials which are designed to improve the processability of the polymeric blend components or modify the properties of the reinforced composition. Such additives may be incorporated prior to, together with or subsequent to the blending of the components and the mixing with the glass fibers. The resulting compositions are processed by conventional methods such as injection molding, pressure forming, sheet extrusion, and other procedures known in the art. Single-screw and, preferably, twin-screw extruders, comprising appropriate feeding, conveying and kneading elements, can be employed to produce the molding materials according to the present invention.

Lubricants and mold release agents are usually not required when using the modified polyamides of the present invention due to the improved lubrication and wettability of the latter of various fillers, although they can be used if desired. That is, they can be processed with no processing aids such as aluminum stearate, calcium stearate, ethylene bis-stearamide, etc.

The amount of short glass fibers to be incorporated into the compositions of the invention is from about 5% by weight to about 80% by weight, based on total reinforced composition, preferably from about 20% to about 65% by weight, based on total reinforced composition. The amount of long glass fibers to be incorporated into the compositions of the present invention is from about 5% by weight to about 80% by weight, based on total reinforced composition, preferably from about 20% to about 65% by weight, based on total reinforced composition.

Flame-retardant compounds, suitable with the polyamide compositions of the present invention, include but are not limited to, red phosphorus, melamine derivatives such as melamine phosphate, polyphosphate or pyrophosphate, halogenated compounds, particularly brominated compounds, and compounds based on magnesium hydroxide. It is recommendable to use a synergist in the case of employing halogen-containing flame retardants. Compounds comprising antimony, boron and tin are suitable for this purpose. Therefore, the modified polyamide having improved wettability of fillers and improved lubrication property with no need of adding flowability enhancers is excellent as the matrice polymer for making flame-retardant compositions.

The filled compositions, using the modified polyamides according to the present invention as the matrix polymers, have an improved melt-flow index compared with otherwise identical compositions which do not contain a polyhydric alcohol or prepared by adding polyhydric alcohol at the time of compounding. They also have excellent mechanical and thermomechanical properties, and in particular a high deformation temperature under load.

The molded articles produced from molding materials according to the present invention are used for producing interior and exterior parts, especially having structural or mechanical function in the field of electricity, electronics, telecommunication, automobile, transport, packaging, domestic, furniture, sport, apparatus engineering, machine construction, heating installation, air conditioning, sanitary, etc.

Due to the improved wettability of fillers, improved lubrication property and decreased melt viscosity of the polyamide modified by polyhydric alcohol, compounding and molding, even in the presence of high amounts of glass fibers or mineral fillers, can be easily performed. Owing to these characteristics, the modified polyamides can incorporate up to 80 wt % reinforcement while maintaining a superior quality of surface aspect, compared with other standard grades of polyamide. The molding process which employs the composites made of modified polyamides of the present invention has such advantages as cycle time reduction, energy cost saving, reduction of the clamping force, increase of number of cavities, use of smaller injection machines, maintenance cost saving, fewer injection points and smaller runners, less scrap, easier way of injection, reduced equipment wear, excellent surface and paintability. The composites themselves have excellent mechanical properties, and enable significant improvements in productivity, cost saving and open up design, while retaining the thermal, mechanical and chemical properties common to semi-crystalline nylons.

The good flow of modified polyamide in the mould allows the production of intricate parts or parts with small details, without loss of stiffness and strength and with a short cycle time.

Depending on a specific modification, the invented polyamide composites with 50 wt % glass-fibers loading may provide to 80% improvement in spiral-flow test and excellent external appearance (gloss finish), with significant improvement in mechanical properties. Thus, higher flow permits shorter cycle times and lower energy consumption, and makes it feasible to mold at a lower temperature or using a lower-tonnage press, while improved wettability allows improvement in mechanical properties and external appearance.

By using the modified polyamide of the present invention, mechanical properties of filled compositions can be obtained that are out of reach for conventional polyamides.

### EXAMPLES

### Determination of the Physical Properties

Certain processes and tests utilized in illustrating the invention are defined below:

The relative viscosity was determined in an exactly prepared 8.4 wt % nylon solution in formic acid 90%. The flow times of this solution at 25° C. were compared to the flow times of pure 90% formic acid through the same viscometer, Cannon-Fenske tube (ASTM D-789). The Cannon-Fenske Viscometer was calibrated with Standard Viscosity Oil S60 of Cannon Instrument Company.

The carboxyl content of nylon was measured by dissolving 3 g of polymer, weighed with a precision of +/−0.0002 g, in 80 ml of benzyl alcohol at 180-190° C. This solution was titrated with 0.05N sodium hydroxide in benzyl alcohol solution, using phenolphthalein as an indicator. The carboxyl content is conventionally reported as equivalents per 10⁶ grams of polymer, or meq/kg, which is numerically identical. The amine content of nylon was measured by dissolving 3 g of polymer, weighed with a precision of +/−0.0002 g, in 55 ml of a 70/30 purified phenol/methanol. Heating under reflux performs the dissolution. The titration with 0.05 N hydrochloric acid is performed potentiometrically until the equivalent point. The amine content is conventionally reported as equivalents per 10⁶ grams of polymer or meq/kg, which is numerically identical.

The determination of mechanical properties was made on dry molded specimens according to ISO 527 (Tensile modulus [MPa], tensile strength at break [MPa], strain at yield [%], strain at break [%]) or according to ISO 180 (notched impact strength, Izod, [KJ/m²), according to ISO 180 (Charpy Impact, [KJ/m²]) according to ISO 178 (flexural strength [MPa], flexural modulus [MPa],) and according to ISO 75 (heat deflection temperature, [° C.]), respectively.

Molded articles for the determination of mechanical and thermal material properties were produced on an injection molding machine Arburg 221K. The determination of rheology properties was made using dried polymer: MVR [1.2 kg at 270° C., (g/10 min)] according to ISO 1133 and Spiral flow test [spiral length (inch])] (1100 Bar, 280° C.), according to the company's internal standard.

The evaluation of surface quality of molded articles was made exemplary on flat specimens having a length of 65 mm and a width of 40 mm by visual observation of fillers at the surface (“no”: very good, no optically visible markings or other defects over the whole specimen surface, “yes”: poor optically visible markings and/or “tiger skin structure” over large regions and/or wrinkle formation).

Extractable amount of polyhydric alcohol was determined as the difference in percentage between initial weight of tested polymer and weight of polymer after extracting polyhydric alcohol from the polymer by boiling in ethanol under reflux for 2 hours, while excluding weight of extracted oligomers.

Yellowness Index was measured according to D1925.

The following Examples are presented to provide a more complete understanding of the invention and are not to be construed as limitations thereon.

### Comparative Example 1

A 89.2 kg nylon 66 salt solution, prepared from hexamethylenediamine and adipic acid in water, with a pH of around 7.6 and a nylon salt concentration of 52%, was charged into an evaporator. Then 4 g of a conventional antifoam agent was added as aqueous 10% solution to the evaporator. Under inert atmosphere, this reaction mixture was then heated to a boil (about 160° C.) under slight pressure to remove the excess water and thus increase its concentration. A slight pressure is desirable to minimize the loss of volatile materials like hexamethylenediamine. The resulting solution was then concentrated to 85%. The concentrated solution was then charged into an autoclave and heated, while the pressure was allowed to rise to 18 atm. to again minimize loss of volatile organic compounds. Then steam was vented and heating was continued until the temperature of the batch reached 254° C. The pressure was then reduced slowly to ca. 1 atm., while the batch temperature was allowed to further rise to 275° C. While maintaining approximately the same temperature, the reaction mixture was held at the low constant pressure for 35 min. to obtain the desired extent of reaction. Finally, the polymer melt was extruded from the autoclave into strand, cooled, and cut into pellets. This polymer is referred to as A in Table 1.

### Comparative Example 2

The molten polymer A prior to discharge from the autoclave was added with 0.2% of amide lubricant (Acrawax C, product of Lonza), mixed, extruded into strand, cooled, and cut into pellets. The pellets were dried in a rotary dryer under vacuum at 115° C. After breaking the vacuum mold release agent powder (Licowax OP, product of Clariant) was added at the temperature into the dryer in an amount of 0.1% of the polymer weight to cover the polymer pellets with the molten ZnSt. The contents of the drier were cooled to 35° C., and discharged. The obtained polymer is referred to as B in Table 1.

### Comparative Examples 3, 4 and 5

Pellets of polymer A (dried to 1500 ppm humidity) of comparative Example 1 were melt-compounded with 2% (of the polymer weight) of a corresponding polyhydric alcohol in Theysohn double screw extruder (Ø25 mm). Pentaerythritol, dipentaerythritol, and trimethylolpropane were employed in comparative Examples 3, 4 and 5, respectively. The obtained polymers are referred to as C, D and E in Table 1, respectively.

### Working Examples 1-5

Using essentially the same batch process and identical amounts of the same reactants used to prepare A, the polymers were prepared according to the method of the present invention in the presence of a polyhydric alcohol. In Examples 1-3 pentaerythritol together with a prescribed amount of adipic acid was added to the nylon salt as aqueous 45 wt % solution at 85° C. prior to the polymerization stage in amounts of 0.25%, 0.5% and 2% by weight of the resulting polymer, respectively. The obtained polymers are referred to as F, G and H, in Table 1, respectively. In Example 4 dipentaerythritol was added to the nylon salt as 30 wt % slurry in water in an amount of 2% by weight of the resulting polymer. The obtained polymer is referred to as I in Table 1. In Example 5 pentaerythritol was added to the nylon salt as aqueous 50 wt % solution at ambient temperature prior to the polymerization stage in an amounts of 2% by weight of the resulting polymer. In all of the Examples adipic acid is added together with the polyhydric alcohol in amounts as shown in Table 1 to obtain polymers having similar values of amino and carboxyl end groups. The obtained polymer is referred to as J in Table 1.

TABLE 1

| | | Comparative Examples | | | | | Working Examples | | | | |
|---|---|---|---|---|---|---|---|---|---|---|---|
| | | 1 | 2 | 3 | 4 | 5 | 1 | 2 | 3 | 4 | 5 |
| Polymer | Unit | A | B | C | D | E | F | G | H | I | J |
| Polyhydric | | — | — | penta- | ditri- | trimethylol | penta- | penta- | penta- | dipenta- | tri- |
| alcohol | | | | erythritol | methylol | propane | erythritol | erythritol | erythritol | erythritol | methylol |
| | | | | | propane | | | | | | propane |
| Amount | % | — | — | 2 | 2 | 2 | 0.25 | 0.5 | 2 | 2.4 | 2.5 |
| of added | by wt. | | | | | | | | | | |
| polyhydric | | | | | | | | | | | |
| alcohol | | | | | | | | | | | |
| Other | % by wt | — | *0.2 | — | — | — | Adipic | Adipic | Adipic | Adipic | Adipic |
| additives | | | | | | | Acid | Acid | Acid | Acid | Acid |
| | | | **0.1 | | | | 0.0225 | 0.0425 | 0.175 | 0.175 | 0.175 |
| Relative | — | 47.8 | 48.8 | 43.8 | 44.2 | 44.0 | 41.2 | 35.8 | 25.0 | 32.8 | 24.9 |
| viscosity | | | | | | | | | | | |
| MVR | g/10 min | 28 | 28 | 53 | 25.6 | 38.3 | 29 | 42 | 138 | 47 | 173 |
| Spiral length | inch | 41 | 42.5 | 43.8 | 40 | 44 | 42 | 46 | >66 | 47.5 | 65 |
| Notched Izod | KJ/m² | 5.3 | 5.4 | 4.2 | 5.1 | 5.1 | 5.3 | 5.1 | 4.3 | 3.9 | 4.0 |
| Tensile | MPa | 81 | 82 | 82 | 83.8 | 90.5 | 82 | 84.3 | 86 | 82 | 84 |
| strength | | | | | | | | | | | |
| Strain | % | 4.5 | 4.5 | 4.3 | 4.5 | 4.5 | 4.7 | 4.7 | 4.3 | 3.8 | 4.0 |
| at yield | | | | | | | | | | | |
| Flexural | MPa | 120 | 124 | 130 | 133.1 | 134 | 126 | 127 | 127 | 130 | 130 |
| strength | | | | | | | | | | | |
| Flexural | MPa | 2850 | 2850 | 2740 | 3101 | 3104 | 2740 | 2783 | 2757 | 3071 | 3024 |
| modulus | | | | | | | | | | | |
| Amount of | % | — | — | 1.9 | 1.95 | 1.9 | 0 | 0 | 0.46 | 0.26 | 0.83 |
| extracted | by | | | | | | | | | | |
| polyhydric | weight | | | | | | | | | | |
| alcohol, % | | | | | | | | | | | |
| Amino End | meq/kg | 47.5 | 46.5 | 46.8 | 47.1 | 47.0 | 48.3 | 54.3 | 70.1 | 66.5 | 71.5 |
| Groups | | | | | | | | | | | |
| Carboxyl | meq/kg | 73.0 | 69.2 | 73.1 | 74.2 | 73.8 | 79.6 | 73.9 | 56.4 | 66.0 | 35.9 |
| End | | | | | | | | | | | |
| Groups | | | | | | | | | | | |
| | | White | Slightly | Very | Very | Very | White | White | White | White | White |
| Notes | | No | Yellowish | discolored | discolored | discolored | No | No | No | No | No |
| | | bleeding- | Mold | Bleeding- | Bleeding- | Bleeding- | Bleeding- | bleeding- | bleeding- | bleeding- | bleeding- |
| | | out | deposits | out | out | out | out | out | out | out | out |

*amide lubricant (Acrawax C);
**mold release agent (Licowax OP)

Polymers prepared by melt-compounding polyamide and polyhydric alcohol in extruder (polymers C, D, and E of Comparative Examples) have substantially lower fluidity, characterized by MVR (melt volume-flow rate), and spiral length than polyamides modified with the same amount polyhydric alcohol at the time of polymerization (H, I and J of working Examples). Molded articles produced from the polymers prepared by melt-mixing in extruder (polymers C, D, and E of the Comparative Examples) suffer from discoloration. The molding process was unstable, followed by bleeding out of the additives and formation of deposits in vent pipe of the extruder and at the mold. Polyhydric alcohol was completely extractable by methanol from the polymers prepared in extruder, while it could be only partially extracted from the polymers F, G, H, I, J of the Working Examples of the present invention. No change in the amount of amino and carboxyl end groups was observed in the polymers obtained by melt-compounding of polyamide with polyhydric alcohols (C, D, and E of Comparative Examples), while amount of amino and carboxyl end groups changed in the modified polymers due to interaction with polyhydric alcohol. Polymers F, G, H, I, J did not exhibit discoloration and bleeding-out at the time of molding, and had mechanical properties similar to unmodified polyamide A of the Comparative Examples. Polymers modified with a higher amount of polyhydric alcohol (H, I, and J) are especially suitable for filled compositions exemplified in the further Examples.

Polymers F and G of the Working Examples modified with a relatively small amount of polyhydric alcohol show better fluidity characterized by MVR and spiral length as compared to both virgin polymer A and polymer B added with amide lubricant Acrawax C and mold release agent Licowax OP of the Comparative Examples. Polymers F and G are especially suitable for production of unfilled molded articles at a higher production rate than one possessed by flowability properties of the conventional lubricated polymer B of Comparative Example.

### Working Examples 6-9

In these Examples a series of heat and light stabilized polymers were made by adding the polyamide modified by polyhydric alcohol with phosphorus-containing, hindered phenol and hindered amine compounds, taken in amounts sufficient for effectively stabilizing polyamide to demonstrate fluidity and mechanical properties of the heat and/or light stabilized polyamides prepared according to the method of the present invention. The polymers were prepared according to the procedure of Working Examples 1-3 with the addition of the chemicals to aqueous 85 wt % nylon salt solution

TABLE 2

| | Working Examples | | | | |
|---|---|---|---|---|---|
| | | 6 | 7 | 8 | 9 |
| Polymer | Unit | K | L | M | N |
| Polyhydric alcohol | | Pentaerythritol | Pentaerythritol | Pentaerythritol | Pentaerythritol |
| Amounts of additives, | g | | | | |
| (per 40 kg polymer batch): | | | | | |
| Polyhydric alcohol | | 100 | 200 | 200 | 200 |
| Adipic acid | | | 19 | 19 | 30 |
| Sodium hypophosphite | | — | 16.6 | 16.6 | 16.6 |
| monohydrate | | | | | |
| 4-amino-2,2,6,6- | | — | — | 90 | 45 |
| tetramethylpiperidine | | | | | |
| 3,5-di-t-butyl-4- | | 80 | — | — | 50 |
| hydroxyphenyl-propionic | | | | | |
| acid | | | | | |
| Relative viscosity | | 37 | 39.6 | 37.5 | 37.4 |
| MVR | g/10 | 39.1 | 40.5 | 41.2 | 46.3 |
| | min | | | | |
| Spiral length | Inch | 45 | 46 | 47 | 46 |
| Notched Izod | KJ/m² | 4.8 | 4.9 | 5.5 | 5.3 |
| Tensile strength | MPa | 85 | 82 | 82 | 80 |
| Strain at yield | % | 4.6 | 4.5 | 4.5 | 4 |
| Flexural strength | MPa | 129 | 126 | 125 | 125 |
| Flexural modulus | MPa | 2840 | 2795 | 2760 | 2763 |
| Yellowness Index of | | 2.0 | −2.3 | −4.3 | −2.0 |
| polymer (pellets) | | | | | |
| Yellowness Index of | | −24 | −29 | −28 | −28 |
| polymer | | | | | |
| (specimen of 3 mm | | | | | |
| thickness) | | | | | |

prior to the polymerization stage. Sodium hypophosphite was added as aqueous 10% solution, 4-amino-2,2,6,6-tetramethylpiperidine (made by Huls America, Inc., of Germany) was added as is. In Example 9, 3,5-di-t-butyl-4-hydroxyphenyl-propionic acid (supplied by Rionlon, Tianjin, Industry Co., China) was added as aqueous solution of a water-soluble salt formed by 3,5-di-t-butyl-4-hydroxyphenyl-propionic acid with 4-amino-2,2,6,6-tetramethylpiperidine. All the stabilized polymers show improved Yellowness Index (measured on pellets and 3 mm thickness flat specimen) as compared to polymer B of Comparative Example 2, having Yellowness Index (measured on pellets and 3 mm thickness specimen) 2.0 and 22, respectively.

### Working Examples 10-14

In these Examples the modified polymers were made by varying amounts of polyhydric alcohol and added adipic acid and hexamethylenediamine, and also with combining two different polyhydric alcohols. In further Examples the polymers serve as a matrice polymer for compounding with glass fibers.

TABLE 3

| | Working Examples | | | | | |
|---|---|---|---|---|---|---|
| | | 10 | 11 | 12 | 13 | 14 |
| Polymer | Unit | O | P | R | S | T |
| Polyhydric alcohol | | Pentaerythritol | Pentaerythritol | Pentaerythritol | Pentaerythritol | Pentaerythritol |
| | | | | | | trimethylolpropane |
| Amount of additives | g | | | | | |
| per 40 kg polymer | | | | | | |
| batch | | | | | | |
| pentaerythritol | | 770 | 770 | 1000 | 2000 | 385 |
| trimetylolprop. | | | | | | 340 |
| adipic acid | | — | 510 | 90 | 180 | 70 |
| hexamethylene | | 168 | — | — | — | |
| diamine (aqueous | | | | | | |
| 33% solution) | | | | | | |
| Relative viscosity | | 23.7 | 21.9 | 21.2 | 15.4 | 26.6 |
| MVR | g/10 min | 120 | 149 | 186 | 430 | 108 |
| Notched Izod | KJ/m² | 4.2 | 3.9 | 3.6 | 2.4 | 4.7 |
| Tensile strength | MPa | 86 | 82 | 80 | 54 | 83 |
| Strain at yield | % | 7.5 | 7.3 | 15 | 1.8 | 4.5 |
| Flexural strength | MPa | 130 | 132 | 130 | 104 | 138 |
| Flexural modulus | MPa | 2962 | 3045 | 2997 | 2885 | 3203 |

### Comparative Examples 6-7

### Working Examples 15-22

The molding materials were produced on a twin-screw extruder (Theysohn Ø25 mm). All components, with exception of the glass fibres, were mixed previously and introduced into the feed zone. The glass fibres were introduced into the melt by a Brabender side feeder. The compounding was made at a screw rotation rate of ca. 360 rpm and an output of 34.5 and 44.7 kg/h. Upon cooling the extruded strands into a water bath they were granulated, then dried at 120° C. before a further processing. The short glass fibers used in the Example were Nittobo grade CS3G495.

A comparison of Working Examples 15-22 to Comparative Examples 6-7 shows that the 50% glass-filled composites prepared from polymers modified by polyhydric alcohol (HH, II, JJ, OO, PP, RR, SS, TT of working Examples 15-22) are significantly superior to the composite prepared from the conventional polyamide (AA of comparative Example 6) and the composite prepared with the addition of polyhydric alcohol into the extruder at the time of compounding (AB of comparative Example 7) in flowability characterized by spiral length and mechanical properties. The composites of the present invention were made at lower temperature and less energy consumption at the same or much larger throughput, and with no additional processing aid like calcium stearate, ethylene bis-stearamide etc. Specimens molded from the composites of the present invention had a nicer appearance similar to specimens molded from 30% glass-filled composites using the conventional polyamide, and with no discoloration and visible defects on the surface as compared to composites AA and AB of Comparative Examples 6 and 7.

TABLE 4

| | | Comparative Examples | | Working Examples | | |
|---|---|---|---|---|---|---|
| | | 6 | 7 | 15 | 16 | 17 |
| Polymer | Units | AA | AB | HH | II | JJ |
| Matrice polymer | | A of | A of | H of | I of | J of |
| | | Comp. | Comp. | Working | Working | Working |
| | | Example | Example | Example | Example | Example |
| | | 1 | 1 | 3 | 4 | 5 |
| Additives- | | | | | | |
| pentaerythritol | | | | | | |
| calcium | wt % of | — | 0.75 | — | — | — |
| stearate | polymer | 0.3 | — | — | — | — |
| Irganox B1171 | | 0.5 | 0.5 | 0.5 | 0.5 | 0.5 |
| Spiral length | Inch | 23 | 25 | 28 | 30 | 23 |
| Notched Izod | KJ/m² | 16.1 | 11.3 | 16 | 15.5 | 18.7 |
| Tensile strength | MPa | 209 | 205 | 253 | 228 | 248 |
| Strain at break | % | 2.4 | 2.1 | 2.4 | 2.3 | 2.2 |
| Flexural | MPa | 357 | 290.7 | 360 | 355 | 391 |
| strength | | | | | | |
| Flexural | MPa | 16667 | 11215 | 13960 | 15654 | 16782 |
| modulus | | | | | | |

Parameters of compounding

| | | | | | | |
|---|---|---|---|---|---|---|
| Extrusion | ° C. | 310 | 305 | 282 | 292 | 302 |
| temperature | | | | | | |
| Rotational speed | rpm | 356 | 360 | 360 | 358 | 359 |
| of the screw | | | | | | |
| Composition | Kg/hour | 34.5 | 34.5 | 34.5 | 34.5 | 34.5 |
| throughput | | | | | | |
| Torque of the | kW | 6.5 | 6.0 | 5.2 | 4.8 | 5.6 |
| motor | | | | | | |
| Motor power | % | 55 | 50 | 45 | 40 | 45 |
| absorbed | | | | | | |
| Observation of | | | | | | |
| fillers on the | | Yes | No | No | No | No |
| surface of | | | | | | |
| specimen | | | | | | |
| Notes | | low | very discolored, | | | |
| | | throughput | non-homogeneous a | | | |
| | | | large amount of | | | |
| | | | flashing, vent deposits | | | |

| | | Working Examples | | | | |
|---|---|---|---|---|---|---|
| | | 18 | 19 | 20 | 21 | 22 |
| Polymer | Units | OO | PP | RR | SS | TT |
| Matrice polymer | | O of | P of | R of | S of | T of |
| | | Working | Working | Working | Working | Working |
| | | Example | Example | Example | Example | Example |
| | | 10 | 11 | 12 | 13 | 14 |
| Additives- | | | | | | |
| pentaerythritol | | | | | | |
| calcium | wt % of | — | — | — | — | — |
| stearate | polymer | — | — | — | — | — |
| Irganox B1171 | | 0.5 | 0.5 | 0.5 | 0.5 | 0.5 |
| Spiral length | Inch | 35 | 30 | 34 | 44 | 35 |
| Notched Izod | KJ/m² | 17.1 | 18.0 | 16.3 | 15 | 15.5 |
| Tensile strength | MPa | 223 | 231.4 | 253.8 | 210 | 218 |
| Strain at break | % | 2.1 | 1.8 | 2.4 | 1.7 | 2.5 |
| Flexural | MPa | 378 | 385 | 387 | 335 | 365 |
| strength | | | | | | |
| Flexural | MPa | 16910 | 15557 | 16879 | 15296 | 16169 |
| modulus | | | | | | |

Parameters of compounding

| | | | | | | |
|---|---|---|---|---|---|---|
| Extrusion | ° C. | 289 | 289 | 288 | 280 | 289 |
| temperature | | | | | | |
| Rotational speed | rpm | 358 | 363 | 363 | 362 | 358 |
| of the screw | | | | | | |
| Composition | Kg/hour | 34.5 | 44.7 | 44.7 | 44.7 | 34.5 |
| throughput | | | | | | |
| Torque of the | kW | 4.3 | 4.8 | 4.6 | 3.9 | 4.5 |
| motor | | | | | | |
| Motor power | % | 36 | 43 | 39 | 31 | 37 |
| absorbed | | | | | | |
| Observation of | | | | | | |
| fillers on the | | No | No | No | No | No |
| surface of | | | | | | |
| specimen | | | | | | |
| Notes | | | | | | |

### Working Examples 23-24

Examples 23-24 demonstrate the production of the modified polyamide of the present invention at a commercial scale.

### Working Example 23

A 4,906 kg nylon 66 salt solution, prepared from hexamethylenediamine and adipic acid in water, with a pH of around 7.6 and a nylon salt concentration of 52 wt %, was charged into an evaporator. Then 200 g of a conventional antifoam agent was added as aqueous 10% solution of to the evaporator. Under inert atmosphere, this reaction mixture was then heated to a boil (about 160° C.) under slight pressure to remove the excess water and thus increase its concentration. The resulting solution was then concentrated to 85%. The concentrated solution was then charged into an autoclave and heated, while the pressure was allowed to rise to 18 atm. At this stage an aqueous 45% solution of 44 kg pentaerythritol and 4 kg adipic acid was introduced into the autoclave. Then steam was vented and heating was continued until the temperature of the batch reached 254° C. The pressure was then reduced slowly to ca. 1 at, while the batch temperature was allowed to further rise to 275° C. While maintaining approximately the same temperature, the reaction mixture was held at the low constant pressure for 40 min. Finally, the polymer melt was extruded from the autoclave into strand, cooled, and cut into pellets. This polymer is referred to as U in Table 5.

### Working Example 24

Using essentially the same batch process and identical amounts of the same reactants used to prepare polymer U, Example 24 differs from Working Example 23 in that the reaction mixture was held at atmospheric pressure for 35 min. This polymer is referred to as V in Table 5.

TABLE 5

| | | Working Examples | |
|---|---|---|---|
| | | 23 | 24 |
| Polymer | Unit | U | V |
| Polyhydric alcohol | | pentaerythritol | pentaerythritol |
| Amount of additives, | kg | | |
| per 2200 kg polymer batch | | | |
| polyhydric alcohol | | 44 | 44 |
| adipic acid | | 4 | 4 |
| Time of keeping at atm. | Min | 40 | 35 |
| Pressure | | | |
| Relative viscosity | | 28 | 24.4 |
| MVR | g/10 min | 104 | 132 |
| Spiral length | Inch | 61 | 66 |
| Notched Izod | KJ/m² | 4.9 | 4.6 |
| Tensile strength | MPa | 84 | 84 |
| Strain at break | % | 31 | 33 |
| Strain at yield | % | 4.3 | 4.3 |
| Tensile modulus | MPa | 2840 | 2887 |
| Flexural strength | MPa | 129 | 126 |
| Flexural modulus | MPa | 2877 | 2940 |

### Working Examples 25-26

Examples 25-26 demonstrate 50 wt % short glass fibers reinforced composites prepared from polymer U of Working Example 23 and polymer V of Working Example 24, respectively.

### Working Examples 27-28

### Comparative Example 8

Working Examples 27 and 28 demonstrate 50% and 60 wt % long glass fibers reinforced composites prepared by pultrusion from polymer U of Working Example 23 and polymer V of Working Example 24, respectively. In Comparative Example 8 the polymer used as the matrice polymer for the preparation of 50 wt % long glass fibers reinforced composite by pultrusion using silanated long glass fibers was a conventional polyamide 66 having relative viscosity of 36.

TABLE 6

| | | Working Examples | |
|---|---|---|---|
| | | 25 | 26 |
| Polymer | Units | UU | VV |
| Matrice | | U of | U of |
| polymer | | Working. Example | Working. Example |
| | | 23 | 24 |
| Additives | % by weight | | |
| | of matrice | | |
| | polymer | | |
| Lowinox 1790 | | 0.1 | 0.1 |
| PEP-36 | | 0.1 | 0.1 |
| Spiral length | Inch | 28 | 32 |
| Notched Izod | KJ/m² | 15.3 | 16 |
| Tensile | MPa | 231 | 252 |
| strength | | | |
| Strain at break | % | 2.6 | 2.4 |
| Tensile | MPa | 15094 | 15400 |
| modulus | | | |
| Flexural | MPa | 361 | 356 |
| strength | | | |
| Flexural | MPa | 15690 | 14900 |
| modulus | | | |
| Observation of | | No | No |
| fillers on the | | | |
| surface of | | | |
| specimen | | | |
| HDT | ° C. | 255 | 255 |
| Extrusion | ° C. | 282 | 282 |
| temperature, | | | |
| Rotational | rpm | 360 | 360 |
| speed of the | | | |
| screw | | | |
| Composition | kg/hour | 34.5 | 34.5 |
| throughput, | | | |
| Torque of the | kW | 5.2 | 4.8 |
| motor | | | |
| Motor power | % | 45 | 43 |
| absorbed | | | |

A comparison of Working Examples 27 and 28 to Comparative Example 7 shows that long fibers reinforced composite using the polyamide modified with polyhydric alcohol demonstrates superior mechanical properties which are out of reach if using the conventional polyamide. Moreover, the long glass fibers composites of the invention can be produced at significantly less die temperature and at larger throughput then ones based on the conventional polyamide as the matrix polymer.

TABLE 7

| | | | | Comparative |
|---|---|---|---|---|
| | | Working Examples | | Example |
| | | 27 | 28 | 7 |
| Polymer | Units | UUU | VVV | WWW |
| Matrice polymer | | U of | U of | Conventional |
| | | Working. Example | Working. Example | Polyamide 66 |
| | | 23 | 24 | With RV 36 |
| Additives | % by wt. | | | |
| Anox 20 | of | 0.1 | 0.1 | 0.1 |
| Alkanox P-27 | polymer | 0.1 | 0.1 | 0.1 |
| Notched Izod Impact | KJ/m² | 27.1 | 31.7 | 17.3 |
| Notched Charpy Impact | KJ/m² | 28 | 31.8 | 20.3 |
| Tensile strength | % | 239 | 257 | 213 |
| Strain at break | % | 2.1 | 1.8 | 2.1 |
| Tensile modulus | MPa | 19100 | 21200 | 14884 |
| Flexural strength | MPa | 380 | 424 | 304 |
| Flexural modulus | MPa | 19000 | 22367 | 13632 |
| Observation of fillers | | no | no | Yes |
| on the surface of | | | | |
| specimen | | | | |
| Extrusion temperature | ° C. | 340 | 330 | 350 |
| (die) | | | | |

While this invention has been described in terms of some specific examples, many modifications and variations are possible. It is therefore understood that within the scope of the appended claims, the invention may be realized otherwise than as specifically described.

1. A polymeric matrix suitable for manufacturing fiber-reinforced polyamide articles, having improved flowability and wettability, comprising
i) a polyamide; and
ii) at least one polyhydric alcohol containing three or more hydroxyl groups in the molecule; wherein said polymeric matrix is obtained essentially by incorporating said polyhydric alcohol to the monomers or to a polymerization medium of said polyamide prior to or in the course of the polymerization process of said polyamide, and wherein said polyhydric alcohol is chemically bonded at least to a part of the polyamide.

2. A polymeric matrix according to claim 1, wherein the polyamide is obtained by condensation reaction in a mixture selected from mixtures comprising diacids with diamines or salts thereof, mixtures comprising a lactam, and mixtures comprising an aminocarboxylic acid, in the presence of at least one polyhydric alcohol.

3. A polymeric matrix according to claim 1, wherein the polyamide is a copolyamide and is obtained by condensation reaction in a mixture comprising aminocarboxylic acids or lactams with diamines and diacids.

4. A polymeric matrix according to claim 1, wherein the precursors of the polyamide are selected from the group consisting of lactams; monomers and oligomers of a C₂ to C₁₈ amino acid; monomers and oligomers of a C₂ to C₁₈ alkyl diamine with a C₂ to C₁₈ aliphatic diacid; monomers and oligomers of a C₂ to C₁₈ alkyl diamine with a C₈ to C₂₄ aryl diacid or aryl diacid derivative; monomers and oligomers of a C₆ to C₂₄ aryl diamine with a C₈ to C₂₄ aryl diacid or aryl diacid derivative; monomers and oligomers of a C₆ to C₂₄ aryl diamine with a C₂ to C₁₈ alkyl diacid or alkyl diacid derivative; monomers and oligomers of a C₈ to C₁₄ aralkyl diamine with a C₁₀ to C₁₄ aralkyl diacid or diacid derivative; and any combinations thereof.

5. A polymeric matrix according to claim 4, wherein the diacids are selected from the group consisting of adipic acid, sebacic acid, suberic acid, dodecanedioic acid, azelaic acid, terephthalic acid, isophthalic acid, 5-sulfoisophthalic acid, succinic acid, glutaric acid, dodecandioic acid, dimer acid, terephthalic acid, cyclohexane dicarboxylic acid, 2,6-naphthalene dicarboxylic acid, tert-butyl isophthalic acid, and phenylindanedicarhoxylic acid.

6. A polymeric matrix according to claim 4, wherein the diamines are selected from the group consisting of hexamethylene diamine, tetramethylene diamine, pentamethylene diamine, 2-methyl pentamethylene diamine, 3,3-dimethyl-4,4′-diaminocyclohexylmethane, 1,6-diamino-2,2,4-trimethylhexane, 1,6-diamino-2,4,4-dimethylhexane, m-xylylenediamine, p-xylylenediamine, diaminononane, diaminodecane, diaminododecane, 2,2-bis(p-aminocyclohexyl)propane, bis(p-aminocyclohexyl)methane, isophorondiamine, polypropyleneglycoldiamine, norbornanediamine, and 1,3-bis(aminomethyl)cyclopentane.

7. A polymeric matrix according to claim 4, wherein the lactams are selected from caprolactam, laurolactam, and enantholactam wherein the aminocarboxylic acid is either omega-aminoundecanoic acid or omega-aminododecanoic acid.

8. A polymeric matrix according to claim 1, wherein said polyamide is nylon 66.

9. A polymeric matrix according to claim 1, wherein said polyamide is nylon 6.

10. A polymeric matrix according to claim 1, wherein said polyamide is partially branched as a result of said bonding.

11. A polymeric matrix according to claim 1, wherein said polyhydric alcohol contains at least three hydroxyl groups in the molecule.

12. A polymeric matrix according to claim 11, wherein said polyhydric alcohol is selected from the group consisting of trimethylolethane, trimethylolpropane, pentaerythritol, dipentaerythritol, mannitol, and sorbitol.

13. A polymeric matrix according to claim 1, wherein said polyamide contains at least 40 meq/kg of free carboxyl groups.

14. A polymeric matrix according to claim 13, wherein said polyamide contains at least 60 meq/kg of free carboxyl groups.

15. A polymeric matrix according to claim 1, exhibiting improved flowability, wettability, and lubrication, and further exhibiting decreased melt viscosity.

16. A polymeric matrix according to claim 15, having a relative viscosity of 34 or less.

17. A composition comprising the polymeric matrix of claim 1 and at least one filler selected from reinforcing or bulking fillers.

18. A composition according to claim 17, wherein said filler is selected from the group consisting of glass fibers, carbon or inorganic fibers, kaolin, wollastonite, talc, metal powders, and nanoclays.

19. A composition according to claim 18, wherein the glass fibers are short length fibers, preferably present in the composition in an amount in the range of about 5 wt % to about 80 wt %, more preferably of about 20 wt % to about 65 wt %.

20. A composition according to claim 18, wherein the glass fibers are long length fibers, preferably present in the composition in an amount in the range of about 5 wt % to about 80 wt %, more preferably of about 20 wt % to about 65 wt %.

21. A composition according to claim 20, obtained by pultrusion process.

22. A composition according to claim 17, wherein the filler is a flame-retardant.

23. A composition according to claim 17, comprising carbon black, preferably in an amount less than or equal to about 6 wt %.

24. A composition according to claim 17, further comprising at least a second filler selected from the group consisting of mineral fillers, metal powders, UV stabilizers, antioxidants, pigments, dyes, nucleating agents, crystallization accelerators, flame retardants, impact modifiers, conducting additives, anti-fogging agents, optical brighteners, fragrances, fungistatics, oxidation retardants, light and heat stabilizers, flow promoters, lubricants, and mold release agents.

25. A composition comprising
i) a polymeric matrix having improved flowability and wettability comprising polyamide and at least one alcohol containing three or more hydroxyl groups in the molecule, wherein said alcohol is chemically bonded at least to a part of said polyamide;
ii) glass fibers in an amount of from 20 to 80 wt %; and optionally
iii) a second filler.

26. A composition according to claim 25 having a high degree of glass fiber loading, comprising at least 50 wt % glass fibers.

27. A process for the manufacture of a polymeric matrix as defined in claim 1, said process comprising polymerizing a polyamide in the presence of at least one polyhydric alcohol containing three or more hydroxyl groups in the molecule, and optionally introducing a filler to a melt of said polyamide.

28. A process according to claim 27, wherein the polyhydric alcohol is present in an amount in the range of about 0.05 wt % to about 10 wt %, preferably of about 0.1 wt % to about 5 wt %.

29. A process according to claim 27, further comprising adding phosphorus-containing antioxidant, preferably said antioxidant being sodium hypophosphite.

30. A process according to claim 29, wherein said phosphorus-containing antioxidant is present in the polyamide in an amount in the range of about 5 to about 10000 ppm as elemental phosphorus.

31. A process according to claim 27, wherein said polyamide is stabilized with a hindered amine and/or hindered phenol-containing compound bonded to the polyamide amine or carboxyl end groups.

32. A process according to claim 31, wherein said hindered phenol-containing compound is 3,5-di-t-butyl-4-hydroxyphenyl-propionic acid, preferably added in an amount in the range of about 0.05 wt % to about 1.0 wt %, more preferably of about 0.1 wt % to about 0.8 wt %, most preferably of about 0.15 wt % to about 0.5 wt %, optionally added as an aqueous salt solution with the equimolar amount of 4-amino-2,2,6,6-tetramethylpiperidine or hexamethylenediamine or ammonia.

33. A process according to claim 31, wherein said hindered amine compound is 4-amino-2,2,6,6-tetramethylpiperidine, preferably added in an amount in the range of about 0.05 wt % to about 1.0 wt %, more preferably of about 0.2 wt % to about 0.8 wt %, most preferably of about 0.25 to about 0.5 wt %.

34. A process according to claim 27, further comprising adding capping agents, preferably said capping agents being selected from the group consisting of mono- or di-functional acids such as acetic acid, propionic acid, benzoic acid, isophthalic azelaic acid, sebacic acid, terephthalic acid, mono- or di-functional amines such as benzyl amine, tetramethylene diamine, 2-methyl pentamethylene diamine, 3,3′-dimethyl-4,4′-diaminocyclohexylmethane, m-xylylenediamine, p-xylylenediamine, diaminononane, diaminodecane, bis(p-aminocyclohexyl)methane, 1,3-bis(aminomethyl)cyclohexane, and mixtures thereof, most preferably, said capping agents are selected from the group consisting of adipic acid, 3,5-di-t-butyl-4-hydroxyphenyl-propionic acid, hexamethylenediamine, 4-amino-2,2,6,6-tetramethylpiperidine, and mixtures thereof.

35. A polyamide article comprising a polymeric matrix according to claim 1, said article exhibiting excellent mechanical properties and improved surface aspect, and further exhibiting improved rheological properties when molten.

36. A polyamide article comprising a composition according to claim 17, said article exhibiting improved mechanical properties and surface aspect, and further exhibiting improved rheological properties when molten.
